(19) United States
(12) Patent Application Publication
(10) Pub. No.: US 2017/0335834 A1
(43) Pub. Date: Nov. 23, 2017

(54) PUMP FOR FLUID SYSTEM AND METHOD OF OPERATING SAME

(71) Applicant: Caterpillar Inc., Peoria, IL (US)

(72) Inventors: Sunil Bean, Peoria, IL (US); Daniel Puckett, Peoria, IL (US); Andrew Neaville, Mt. Pulaski, IL (US)

(73) Assignee: Caterpillar Inc., Peoria, IL (US)

(21) Appl. No.: 15/162,024

(22) Filed: May 23, 2016

(51) Int. Cl. F04B 17/03; F02M 59/10

(52) U.S. Cl. CPC F04B 17/03; F02M 59/10

(57) ABSTRACT

A fluid system such as a fuel system includes a fluid supply and a pump coupled between the fluid supply and a plurality of fluid delivery devices. The pump can be a cryogenic pump such as for liquefied natural gas, with valve mechanisms to control hydraulic actuation of a piston used to pump the liquefied natural gas. An electrically conductive coil is coupled with the piston. Related methodology is disclosed.

### TECHNICAL FIELD

The present disclosure relates generally to a hydraulically driven pump, and more particularly to such a pump including an electrically conductive coil having electrical properties that vary dependent upon a position of a piston mechanism in the pump.

### BACKGROUND

Hydraulically driven piston pumps are used in a variety of applications, and generally include a piston positioned within a pump housing and having an actuation surface exposed to a hydraulic chamber that can alternately be supplied with a controlled hydraulic actuation pressure. By varying the hydraulic actuation pressure the piston can be induced to move within the pump housing, with a return spring and/or a counteracting fluid pressure acting in concert with the actuation pressure to cause the piston to reciprocate. A pressurization surface upon an end of the piston opposite the actuation surface can be advanced through a pumping chamber to pressurize and/or transfer a fluid.

Such pumps have application, for example, in environments where relatively highly pressurized actuation fluid is readily available, and electrical power or rotational takeoff power such as camshaft power from an engine is not so readily available, or for other reasons is undesired. Hydraulically driven piston pumps have certain of the advantages of other hydraulically driven devices such as hydraulic actuators, for example, relatively high efficiency and reliability. In recent years hydraulically driven piston pumps have been used to pump fuel in certain engine systems, notably engine systems employing gaseous fuel stored on-board in a liquefied state. While applications as so-called cryogenic pumps have seen success, there remain various aspects of operation and construction that are still to be perfected. Commonly owned U.S. Pat. No. 9,228,574 to Puckett is entitled Hydraulic Relief and Switching Logic For Cryogenic Pump System, and is directed at least in part to overcoming shortcomings of certain known systems.

### SUMMARY OF THE INVENTION

In one aspect, a pump includes a pump housing having formed therein a working fluid inlet, a working fluid outlet, an actuation chamber, and a pumping chamber. The pump further includes a valve mechanism adjustable between a first configuration where the valve mechanism fluidly connects the actuation chamber with the working fluid inlet, and a second configuration where the valve mechanism fluidly connects the actuation chamber with the working fluid outlet. The pump further includes a piston mechanism having an actuation surface exposed to the actuation chamber, and an opposite pumping surface exposed to the pumping chamber. The piston mechanism is movable within the pump housing to transition a pumped fluid into or out of the pumping chamber. The pump further includes an electrically conductive coil mounted at a fixed location relative to the pump housing and positioned such that an inductance of the electrically conductive coil is dependent upon a position of the piston mechanism.

In another aspect, a fluid system includes a fluid supply, a plurality of fluid delivery devices, and a pump coupled between the fluid supply and the plurality of fluid delivery devices. The pump includes a pump housing having formed therein at least one working fluid inlet, a plurality of actuation chambers, and a plurality of pumping chambers. The pump further includes at least one valve mechanism adjustable between a first configuration where the valve mechanism fluidly connects at least one of the plurality of actuation chambers with the at least one working fluid inlet, and a second configuration where the valve mechanism fluidly connects the at least one of the plurality of actuation chambers with a low pressure space. The pump further includes a plurality of piston mechanisms each including an actuation surface exposed to one of the plurality of actuation chambers, and an opposite pumping surface exposed to one of the plurality of pumping chambers. The fluid system further includes a plurality of electrically conductive coils positioned such that an inductance of each of the electrically conductive coils is dependent upon a position of a different one of the piston mechanisms.

In still another aspect, a method of operating a fluid system includes adjusting a valve mechanism to change a fluid pressure in an actuation chamber in a pump, and moving a piston mechanism in the pump in a direction of reciprocation in response to the change in fluid pressure. The method further includes moving a pumping element in the direction of reciprocation by way of the moving of the piston mechanism to transition a pumped fluid into or out of a pumping chamber in the pump. The method still further includes detecting an electrical energy state or a change in an electrical energy state of an electrically conductive coil that is produced in response to at least one of the moving of the piston mechanism or a change in the moving of the piston mechanism.

### BRIEF DESCRIPTION OF THE DRAWINGS

FIG. 1 is a diagrammatic view of a system according to one embodiment;

FIG. 2 is a diagrammatic view of a pump suitable for use in the system of FIG. 1;

FIG. 3 is a sectioned side diagrammatic view of a portion of the pump of FIG. 2;

FIG. 4 is a concept diagram illustrating a signal trace for electrical current in comparison with piston positions in a pump, according to one embodiment;

FIG. 5a is a signal trace of voltage over time in an active drive current embodiment of pump piston position detection;

FIG. 5b is a signal trace of electrical current over time in an active drive current embodiment of pump piston position detection; and

FIG. 5c is a signal trace of pump piston displacement over time in the active drive current embodiment.

### DETAILED DESCRIPTION

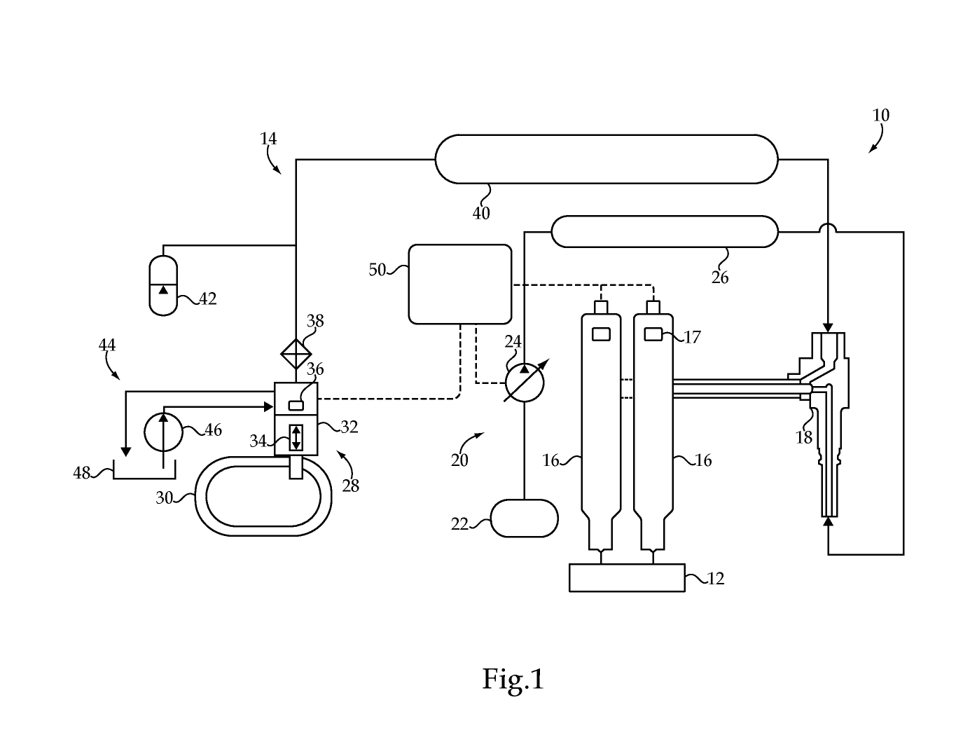

Referring to FIG. 1, there is shown an internal combustion engine system 10 according to one embodiment. System 10 includes an engine such as a multi-cylinder compression ignition engine 12 supplied with one or more fuels from a plurality of fluid delivery devices 16 in the nature of fuel injectors. A quill connector assembly 18, one of which is shown, or any other suitable fluid conveyance mechanism(s) can be provided to supply both a gaseous fuel and a liquid fuel, two liquid fuels, or two gaseous fuels, to each of fluid delivery devices 16 from a first common rail 40 and a second common rail 26. In other instances, unit injectors rather than common rail-fed injectors might be used. An electronically controlled injection control valve 17 may be used with each of devices 16 to control a timing of fuel injection. Devices 16 might include dual checks or a single check for the two fuels, could be hydraulically intensified, hydraulically controlled, or could have virtually any other conceivable features suitable for delivery of at least one fuel into engine 12. While devices 16 might be used to inject each of two different types of fuel, in other instances separate injection devices might be used. As suggested above, embodiments are contemplated where engine system 10 is a single-fuel system rather than a dual-fuel design. It is nevertheless contemplated that at least certain of the teachings set forth in the present disclosure will be advantageously applied to dual-fuel engine systems operating on distillate diesel fuel or a suitable alternative and a gaseous fuel stored cryogenically in a liquefied form such as liquid natural gas (LNG).

Engine system 10 (“system 10”) may further include a fluid system 14 of which at least common rail 26, common rail 40, connector assembly 18, and devices 16 can be considered parts. Fluid system 14 may also include a first fuel subsystem 20 that includes a first fluid supply or fuel supply 22 and a first fuel pump 24 (“pump 24”) structured to transfer liquid fuel such as distillate diesel fuel to common rail 26. Pump 24 or another pump can be used to pressurize the liquid fuel supplied to common rail 26 up to or close to a desired fuel injection pressure. Pump 24 can be electronically controlled and operated to maintain a fuel pressure in rail 26 at the desired pressure, and to this end is coupled with an electronic control unit 50. Electronic control unit 50, further discussed herein, can also be coupled with an electrical actuator for valve 17 or to an electrical actuator of a pilot valve (not shown) for valve 17 and to numerous other components of system 10 for monitoring and/or control purposes. Injection of the first fuel by way of first fuel subsystem 20 may provide a relatively small but readily ignited charge that triggers ignition of a relatively large but less readily ignited charge of a second fuel such as a gaseous fuel.

The second fuel may include a gaseous fuel stored in a liquefied form, and supplied from a second fuel subsystem 28. As used herein the term gaseous fuel can generally be understood to include a fuel that is in a gaseous state at standard temperature and pressure. Fuel subsystem 28 may include a second fluid supply or second fuel supply such as a cryogenic storage tank 30 containing LNG, a second fuel pump 32 (“pump 32”), and a vaporizer 38, structured so as to supply the second fuel in gaseous form to common rail 40. An accumulator 42 may be provided for pressure modulation or other well-known purposes. A hydraulic subsystem 44 is further provided for actuating pump 32, and in particular driving a piston mechanism 34 of pump 32 as further discussed herein. Hydraulic subsystem 44 includes a hydraulic pump 46, and a tank 48. A valve mechanism 36 of pump 32 controls hydraulic connections to and from piston mechanism 34. Electronic control unit 50 may be coupled with valve mechanism 36, and with other components of pump 32 as further discussed herein.

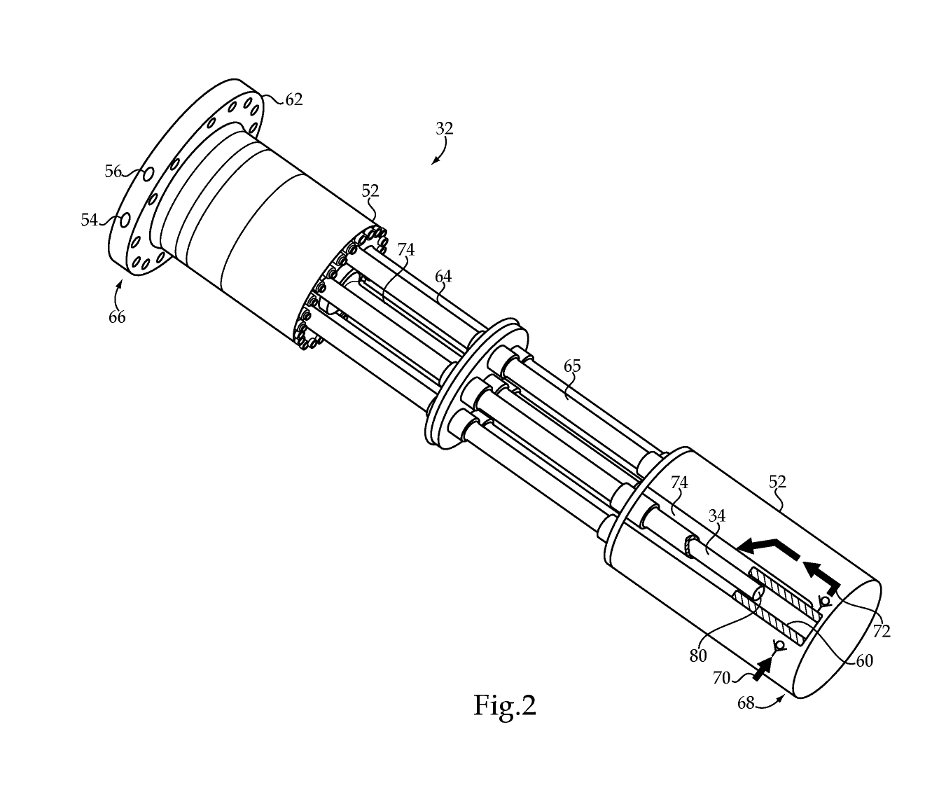

Referring also now to FIG. 2, there are shown additional features of pump 32 in further detail. Pump 32 includes a pump housing 52 having a mounting flange 62 at a warm end 66, and a cold end 68. Although not visible in FIG. 2, piston mechanism 34 as in FIG. 1 and a plurality of substantially identical piston mechanisms will typically be positioned at least partially within pump housing 52 at warm end 66. A working fluid inlet 54 and a working fluid outlet 56 are formed in pump housing 52 for connecting with hydraulic subsystem 44. A pumping chamber 60 is formed in pump housing 52 at cold end 68 and connects with a pumped fluid inlet 70 and a pumped fluid outlet 72. In a practical implementation strategy, at least cold end 68 and possibly more of pump 32 is positioned within tank 30 such that LNG is drawn into pumping chamber 60 by way of inlet 70 and discharged from pumping chamber 60 by way of outlet 72, in response to reciprocation of piston mechanism 34. Piston mechanism 34 as shown in FIG. 2 includes a pumping surface 80 exposed to pumping chamber 60. A single piston member or multiple longitudinally coupled but separate piston elements and a pumping element that includes surface 80 might comprise piston mechanism 34, although the present disclosure is not limited to any particular configuration. The terms “piston mechanism” and “piston” are used interchangeably herein. A single piston member could include all the components of a tappet-like first end, a push rod and a pumping element. The pumped fluid may be conveyed from outlet 72 into an outlet conduit 74 that extends toward warm end 66. In a practical implementation strategy, the plurality of substantially identical piston mechanisms may each be associated with a different pumping chamber at cold end 68, although only the one is shown in FIG. 2. Each of the plurality of pumping chambers may feed into outlet conduit 74. A plurality of sleeves 64 in a first set adjacent to warm end 66 are shown in FIG. 2, and another plurality of sleeves 65 adjacent to cold end 68. The plurality of piston mechanisms can extend through sleeves 64 and 65 generally in parallel with one another at least in some contemplated embodiments.

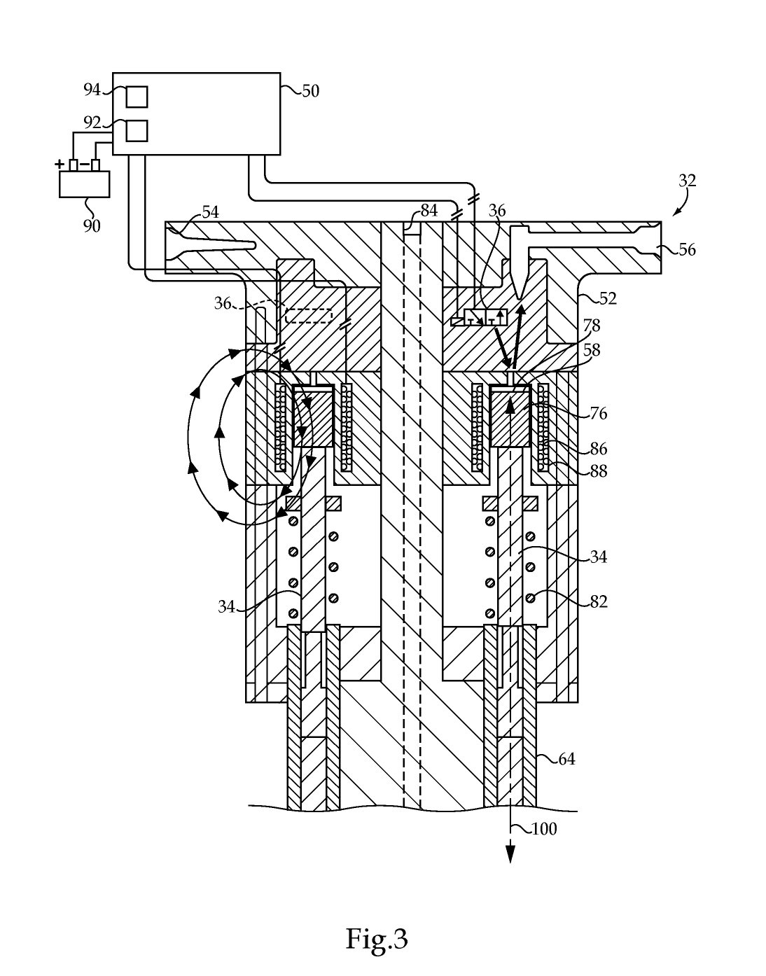

Referring also now to FIG. 3, there is shown a sectioned view through a portion of pump 32 and illustrating still further details. It should be appreciated that two piston mechanisms 34 are depicted in FIG. 3, and may be substantially identical. The present description of piston mechanism 34 in the singular should thus be understood to refer analogously to each of the plurality of piston mechanisms that may be part of pump 32. Piston mechanism 34 includes a first end 76 having an actuation surface 78 exposed to an actuation chamber 58, opposite pumping surface 80 which is not shown in FIG. 3. As explained above, piston mechanism 34 is movable within pump housing 52 to transition the pumped fluid into or out of pumping chamber 60. Valve mechanism 36 is also shown in FIG. 3 and illustrated diagrammatically as a slide-type three-way valve that can be hydraulically actuated or electrically actuated. Valve mechanism 36 could also include a plurality of separate valve elements in other embodiments. A plurality of substantially identical valve mechanisms may be provided and each associated with one piston mechanism 34, and thus the present description of valve mechanism 36 in the singular will be understood to refer analogously to each of the plurality thereof. In other embodiments, a single valve mechanism can be used to distributively supply fluid to a plurality of actuation chambers, for instance. It will thus be understood that pump 32 will typically include at least one valve mechanism as described. The at least one valve mechanism may be electrically actuated, hydraulically actuated, pilot operated, for example, according to a variety of different specific strategies. Valve mechanism 36 is adjustable between a first configuration where valve mechanism 36 fluidly connects actuation chamber 58 with working fluid inlet 54 but not working fluid outlet 56, and a second configuration where valve mechanism 36 fluidly connects actuation chamber 58 with working fluid outlet 56 but not working fluid inlet 54. In a practical implementation strategy pump housing 32 has a single working fluid inlet formed therein that receives pressurized hydraulic fluid from hydraulic subsystem 44 and distributes the pressurized hydraulic fluid to a plurality of actuation chambers in a manner controlled by the plurality of valve mechanisms 36. In other embodiments, pump housing 52 might have a plurality of working fluid inlets formed therein that separately fluidly connect one with each of a plurality of actuation chambers. A plurality of working fluid outlets 56, or any other common or separate and dedicated low pressure space might be provided for providing a low fluid pressure to actuation chamber 58. Those skilled in the art will appreciate that connecting actuation chamber 58 to working fluid inlet 54 to provide high fluid pressure can cause piston mechanism 34 to be advanced in a direction of reciprocation from a retracted position toward an advanced position to execute a pumping stroke to pump fluid from pumping chamber 60. Connecting actuation chamber 58 to working fluid outlet 56 can cause piston mechanism 34 to be retracted in the direction of reciprocation to execute an intake stroke to draw fluid into pumping chamber 60. A return spring 82 causes piston mechanism 34 to retract and expel the working fluid from working fluid outlet 56. It can be noted from FIG. 3 that electronic control unit 50 could be coupled with valve mechanism 36 for energizing and/or de-energizing an electrical actuator such as a solenoid actuator thereof. Embodiments are contemplated, as mentioned above, where electronic control unit 50 would control an electrical actuator of a separate valve that controls hydraulic actuation of valve mechanism 36. An LNG outlet 84 is formed in pump housing 52 and can be fluidly connected with vaporizer 38 to transition the pumped LNG to gaseous form. In a further practical implementation strategy, actuation surface 78 can be larger than pumping surface 60, providing an effective pressure increase from working fluid pressure to pumped fluid pressure of a factor of about two, or greater.

Pump 32 further includes an electrically conductive coil 86 (“coil 86”) mounted at a fixed location relative to pump housing 32 and positioned such that an inductance of coil 86 is dependent upon a position of piston mechanism 34 and in particular first end 76. A plurality of substantially identical coils will typically be provided and paired with each of the piston mechanisms of pump 32. Thus, the present description of coil 86 in the singular should be understood to refer analogously to any of the plurality of coils of pump 32. As will be further apparent from the following description the electrical properties of coil 86 and dependence upon position of piston mechanism 34 can be exploited according to the present disclosure in the detection of a position or a change in position of piston mechanism 34. In the FIG. 3 embodiment, piston mechanism 34 defines an axis of reciprocation 100 and coil 86 extends circumferentially around axis of reciprocation 100. Coil 86 is also shown contained in a cartridge 88 that is installed in pump housing 52. In other embodiments, coil 86 could be embedded in material of pump housing 52 itself. Still further shown in FIG. 3 is an electrical energy supply such as a battery 90 coupled with coil 86 that can provide electrical current for energizing coil 86.

In one practical implementation strategy, electronic control unit 50 includes a microprocessor 94 or other suitable control mechanism that energizes coil 86 for the purposes of generating heat that increases a temperature of components of pump 32 and hydraulic fluid therein. For instance, during startup of engine system 10 relatively low ambient temperatures can result in relatively viscous hydraulic fluid. Producing heat by way of energizing coil 86 can reduce viscosity of the hydraulic fluid and thereby ease the initiation of movement of piston mechanism 34 and/or facilitate the controllability of moving piston mechanism 34. It will be appreciated that a plurality of electrically conductive coils may be provided, each of which could be structured for heating in the manner described. Heat generated by way of such energizing can be conducted through material of pump housing 52 and into hydraulic fluid in actuation chamber 58 and elsewhere in pump housing 52. Applications of the present disclosure to heating can be used in conjunction with position detection and speed control strategies further discussed herein, or could be used independent of such strategies.

In another practical implementation strategy, pump 32 may include a detector 92 coupled with electrically conductive coil 86 and structured to detect an electrical energy state of electrically conductive coil 86 that is induced by at least one of moving of piston mechanism 34 or a change in moving of piston mechanism 34. The electrical energy state may further include an electrical energy state indicative of at least one of a positioning of piston mechanism 34 at the retracted position or a positioning of piston mechanism 34 at the advanced position as described herein. As further described herein the electrical energy states may include induced electrical current amplitudes, although the present disclosure is not thereby limited. Detector 92 could include a resistor placed within or coupled with circuitry that includes coil 86, and suitable current sensing circuitry connected across the resistor, for example. Microprocessor 94 could be coupled with the sensing circuitry and suitably programmed to detect electrical properties that are indicative of the various states of interest further discussed herein. Those skilled in the art will be familiar with phenomena relating to electromagnetic inductance in an electrically conductive coil such as a solenoid, and variation in electromagnetic inductance where a magnetic or a magnetically permeable core is changed in position relative to the electrically conductive coil. Piston mechanism 34, and to some extent potentially material of pump housing 52, may function as a core such that an inductance of electrically conductive coil 86 varies depending upon whether piston mechanism 34 is at a start of stroke position or an end of stroke position. The variation in inductance can result in variation in an electrical energy state of coil 86 such as a magnitude of a freewheeling electrical current or an active driver current as further discussed herein.

Coil 86 is structured to produce a magnetic field and at least first end 76 of piston mechanism 34 is movable through the magnetic field by way of the moving of piston mechanism 34 to vary the inductance of coil 86. Piston mechanism 34 may be movable from a first location within the magnetic field to a second location within the magnetic field, corresponding to an advanced position of piston mechanism 34 and a retracted position of piston mechanism 34, respectively. The magnetic field may have different flux densities at the first location and at the second location, and the presence or absence of piston mechanism 34 may also affect the flux density as well. In FIG. 3 example magnetic field lines are depicted in connection with the electrically conductive coil associated with piston mechanism 34. For clarity of illustration, example magnetic field lines on only one side of coil 86 are shown but would be understood to extend from the other side and through parts of pump housing 32.

As noted above, the variation in inductance in coil 86 can result in variation in electrical properties, in particular varying counter-electromotive force (back EMF) that can affect, for example, freewheeling electrical currents in coil 86 or active driver currents where coil 86 is being energized. When coil 86 is energized by way of electrical energy supply 90 and then disconnected, a freewheeling current can be expected for at least a brief period of time. The changed inductance resulting from change in position of piston mechanism 34 relative to coil 86 can result in a varying back EMF that in turn affects the freewheeling current. Analogous principles of varying inductance generally apply where an active driver current is being applied. By sensing electrical current the variations in freewheeling or active driver current can be detected by detector 92. More generally, in at least certain embodiments an electrical current or changes in an electrical current, in an electrical circuit that includes electrically conductive coil 86, produced in response to movement or a change in movement of piston mechanism 34 can be used to detect position or change of position thereof. Other electrical properties such as voltages or voltage changes, derivatives or integrations of electrical current over time, might be exploited. If parts of piston mechanism 34 such as first end 76 were magnetized still further variations in the relationships between tappet position and electrical energy state of coil 86, as well as still other opportunities for manipulating the motion of piston mechanism 34, could be expected. As further discussed below, peaks and/or troughs in an electrical current signal can serve as the triggers whereby detector 92 detects tappet position. Detector 92 can thus be an electrical current detector, but in other embodiments might be another suitable monitoring or measuring device.

### INDUSTRIAL APPLICABILITY

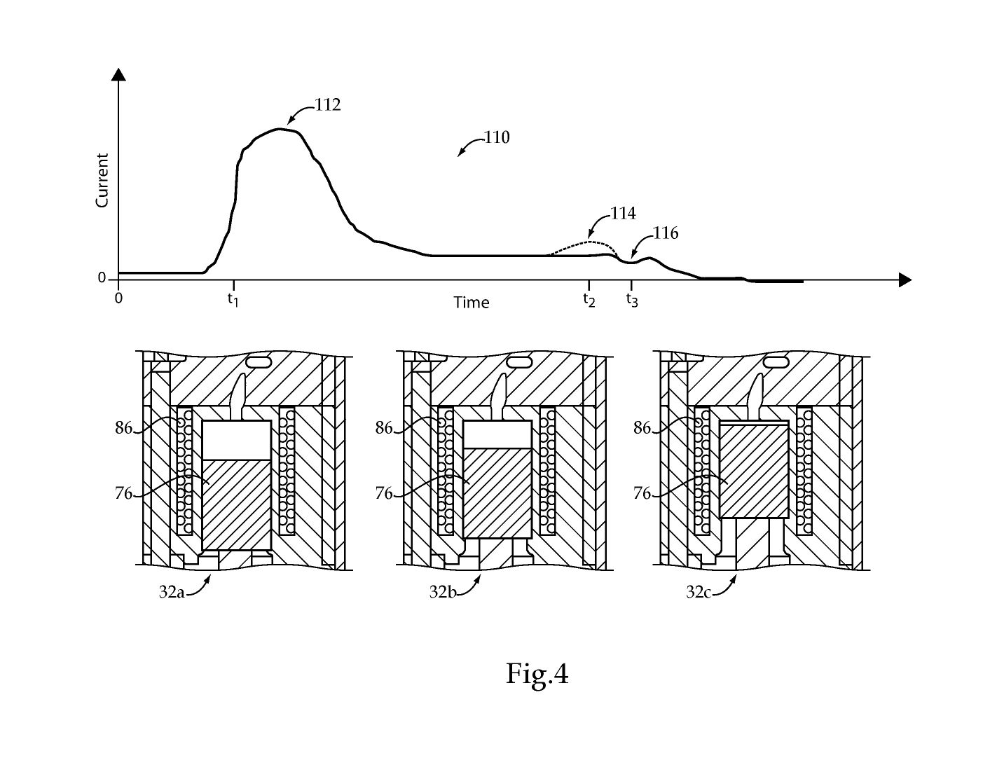

Referring now also to FIG. 4 there is shown a concept diagram that relates a plurality of different piston mechanism and states shown by way of reference numerals 32a, 32b, and 32c to an electrical current signal over time shown by way of a graph 110. At 32a, piston first end 76 is shown as it might appear having advanced through much of a pumping stroke and approaching an end of stroke position. Valve mechanism 36 has been adjusted from the second configuration where actuation chamber 78 is fluidly connected with working fluid outlet, to the first configuration where actuation chamber 78 is fluidly connected with working fluid inlet 54. Hydraulic pressure in actuation chamber 78 has increased to act upon hydraulic surface 58 and urge first end 76 downward against a bias of return spring 82. Pumping surface 80 has advanced through pumping chamber 60 to pump fluid into conduit 74. Coil 86 has been energized by way of electrical energy supply 90, and then disconnected such that the electrical current signal represents freewheeling electrical current. In graph 110, a time t₁ corresponds approximately to the state of pump 32 and position of first end 76 as depicted at 32a. A peak 112 in freewheeling electrical current can be expected to be observed just after time t₁ as piston mechanism reaches the end of stroke position.

At 32b first end 76 is shown as it might appear where piston mechanism 34 is returning under the influence of return spring 82 and is approaching a start of stroke position. Valve mechanism 36 has been adjusted back to the configuration where actuation chamber 58 is fluidly connected to a low pressure space. At 32c first end 76 is shown as it might appear where piston mechanism 34 has reached the start of stroke position. At a time t₃ a trough 116 is shown indicating an example freewheeling current state that might be observed where first end 76 ceases moving.

As piston mechanism 34 moves between the end of stroke position and the start of stroke position the dominant forces controlling the movement of piston mechanism 34 will typically be the result of fluid pressures acting on surfaces 58 and 80, and the force of return spring 82. In some instances, however, it may be desirable to energize or de-energize electrically conductive coil 86 for the purpose of generating or varying a magnetic field to provide attractive or repulsive magnetic forces for hastening or retarding moving of piston mechanism 34 between the end of stroke position and the start of stroke position. Electronic control unit 50 may further be structured to controllably energize one or more electrically conductive coils 86 by way of electrical energy supply 90, for example, so as to produce a magnetic field to pull first end 76 toward the start of stroke position or to oppose the moving toward the start of stroke position. In FIG. 4 a peak 114 shown in a phantom line at approximately a time t2 and represents an example electrical current increase that might be provided to coil 86 for the purpose of inducing or varying a magnetic field to modulate speed of piston mechanism 34 as it returns toward the start of stroke position. Depending upon the construction and materials of piston mechanism 34 and the polarity of the electrical current used to energize coil 86, many variations on the general themes set forth herein of monitoring and/or modulating movement of piston mechanism 34 and thus monitoring and/or controlling pumping stroke speed can be envisioned. It has been discovered that in instances where pump stroking speed is too fast components can be damaged from impacting one another. Stroking too slow can result in inefficient pumping. It has further been observed that moving a piston mechanism too fast can cause LNG to flash to vapor form due to excessive suction. Retarding moving of piston mechanism 34 as described herein can inhibit flashing of the LNG or other liquefied gaseous fuel. Moving a piston mechanism too slow can also result in the piston mechanism not being positioned properly in time for a subsequent pumping stroke. It will be appreciated that the techniques disclosed herein can assist in ameliorating such concerns given improved ability to not only determine and monitor pump state but also modulate stroke speed of one or more piston mechanisms. To such ends, electronic control unit 50 may be structured to determine at least one of stroke time or stroke speed based on the detected electrical energy states as described herein. The operation of any one of a plurality of different piston mechanisms in a pump could even be modulated differently to provide uniform operation among the piston mechanisms with respect to stroke speed and/or timing, or even to intentionally provide non-uniform operation if desired. The present strategy thus contemplates not only techniques for gathering the information that allows differences among operation of the piston mechanisms or departures in operation from a specification to be elucidated, but also techniques for modulating the operation once the differences or departures from specs are understood.

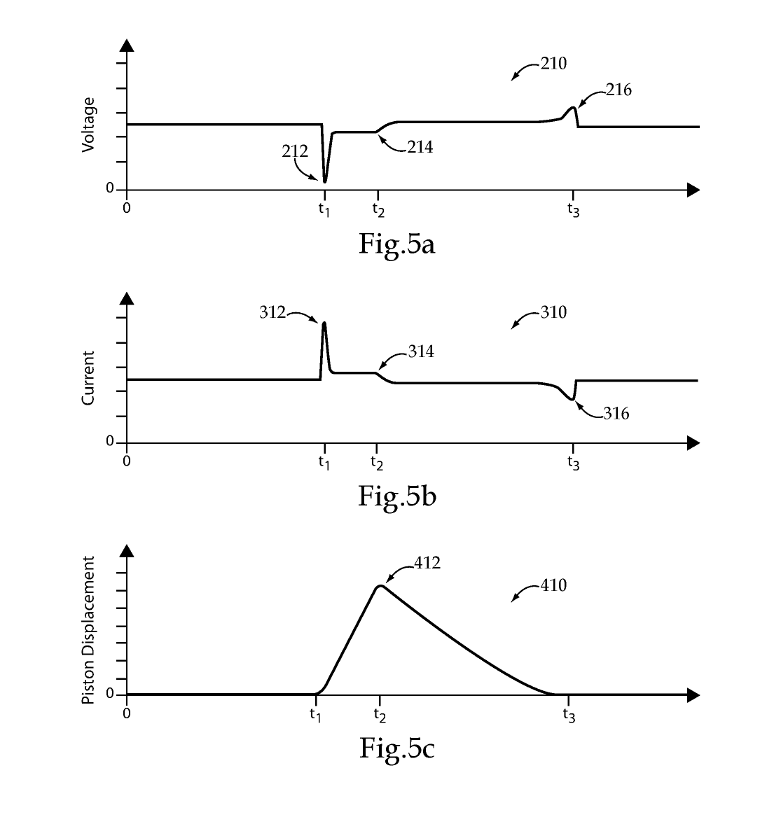

Referring now to FIGS. 5a, 5b, and 5c, there are shown drive voltage 210, electrical current 310, and piston displacement 410 in an active driver current embodiment. As noted above, rather than electrical properties relating to a freewheeling electrical current being monitored to indicate piston start of stroke, end of stroke or other conditions, properties in an active driver current can be monitored to analogously detect behavior or state of a piston mechanism. In FIGS. 5a-c, piston start of stroke occurs at about a time t₁ where a trough 212 in voltage is evident in FIG. 5a, a peak 312 in electrical current is seen in FIG. 5b, and commencing of a change in displacement in FIG. 5c. At about a time t2 an end of stroke state is indicated generally by the initiation of voltage rise at 214, a current decrease at 314, and a maximum piston displacement at peak 412. At about a time t₃ a voltage peak 216, a current trough 316, and a return to minimum piston displacement may be observed. Those skilled in the art will appreciate that in still other instances different electrical properties in an active driver current or a freewheeling current embodiment might be observed and exploited to indicate piston state. Moreover, where active driver current is itself controlled in amplitude to various ends, such as retarding or accelerating piston travel speed, still other patterns and electrical properties and changes in electrical properties can be expected that can be used for control or diagnostic purposes.

The present description is for illustrative purposes only, and should not be construed to narrow the breadth of the present disclosure. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A pump comprising:
a pump housing having formed therein a working fluid inlet, a working fluid outlet, an actuation chamber, and a pumping chamber;
a valve mechanism adjustable between a first configuration where the valve mechanism fluidly connects the actuation chamber with the working fluid inlet, and a second configuration where the valve mechanism fluidly connects the actuation chamber with the working fluid outlet;
a piston mechanism having an actuation surface exposed to the actuation chamber, and an opposite pumping surface exposed to the pumping chamber, and the piston mechanism being movable within the pump housing to transition a pumped fluid into or out of the pumping chamber; and
an electrically conductive coil mounted at a fixed location relative to the pump housing and positioned such that an inductance of the electrically conductive coil is dependent upon a position of the piston mechanism.

2. The pump of claim 1 wherein the piston mechanism defines an axis of reciprocation and the electrically conductive coil extends circumferentially around the axis of reciprocation.

3. The pump of claim 2 further comprising a cartridge containing the electrically conductive coil and installed in the pump housing.

4. The pump of claim 2 further comprising an electrical energy supply coupled with the electrically conductive coil and structured to energize the electrically conductive coil.

5. The pump of claim 1 further comprising a detector coupled with the electrically conductive coil and structured to detect an electrical energy state of the electrically conductive coil that is induced by at least one of moving of the piston mechanism or a change in moving of the piston mechanism.

6. The pump of claim 5 wherein the detector includes an electrical current detector structured to detect electrical currents induced in the electrically conductive coil.

7. The pump of claim 5 wherein the piston mechanism is movable between a retracted position and an advanced position, and the electrical current detector is structured to detect an electrical energy state indicative of at least one of a positioning of the piston mechanism at the retracted position or a positioning of the piston mechanism at the advanced position.

8. The pump of claim 7 wherein the piston mechanism is movable between a first location within the magnetic field and a second location within the magnetic field, corresponding to an advanced position and a retracted position of the piston mechanism, respectively.

9. The pump of claim 8 wherein the magnetic field has different flux densities at the first location and at the second location.

10. A fluid system comprising:
a fluid supply;
a plurality of fluid delivery devices;
a pump coupled between the fluid supply and the plurality of fluid delivery devices, and including a pump housing having formed therein at least one working fluid inlet, a plurality of actuation chambers, and a plurality of pumping chambers;
the pump further including at least one valve mechanism adjustable between a first configuration where the valve mechanism fluidly connects at least one of the plurality of actuation chambers with the at least one working fluid inlet, and a second configuration where the valve mechanism fluidly connects the at least one of the plurality of actuation chambers with a low pressure space;
the pump further including a plurality of piston mechanisms each having an actuation surface exposed to one of the plurality of actuation chambers, and an opposite pumping surface exposed to one of the plurality of pumping chambers; and
a plurality of electrically conductive coils positioned such that an inductance of each of the electrically conductive coils is dependent upon a position of a different one of the piston mechanisms.

11. The system of claim 10 further comprising a detector coupled with the plurality of electrically conductive coils, and being structured to detect an electrical energy state of each of the plurality of electrically conductive coils that is induced by at least one of moving of the corresponding one of the piston mechanisms or a change in moving of the corresponding one of the piston mechanisms.

12. The system of claim 11 further comprising an electronic control unit structured to determine at least one of a stroke time or a stroke speed for each of the piston mechanisms based on the detected electrical energy states.

13. The system of claim 12 wherein the detected electrical energy states are indicative of at least one of an end of stroke position or a start of stroke position of the corresponding piston mechanism.

14. The system of claim 10 further comprising an electrical energy supply coupled with each of the plurality of electrically conductive coils, and an electronic control unit structured to controllably energize each of the plurality of electrically conductive coils by way of the electrical energy supply so as to produce magnetic fields hastening or retarding moving of the corresponding piston mechanism between the end of stroke position and the start of stroke position.

15. The system of claim 10 comprising a fuel system for an engine where the pump includes a cryogenic pump and the fluid supply includes a supply of liquefied gaseous fuel, and further comprising a vaporizer coupled between the supply of liquefied gaseous fuel and the cryogenic pump.

16. The system of claim 15 wherein the at least one fluid delivery device includes a plurality of fuel injectors, and further comprising a common rail coupled between the pump and the plurality of fuel injectors.

17. A method of operating a fluid system comprising:
adjusting a valve mechanism to change a fluid pressure in an actuation chamber in a pump;
moving a piston mechanism in the pump in a direction of reciprocation in response to the change in fluid pressure;
moving a pumping element in the direction of reciprocation by way of the moving of the piston mechanism to transition a pumped fluid into or out of a pumping chamber in the pump; and
detecting an electrical energy state of an electrically conductive coil that is produced in response to at least one of the moving of the piston mechanism or a change in the moving of the piston mechanism.

18. The method of claim 17 wherein the moving of the piston mechanism includes moving the piston mechanism toward a start of stroke position by way of a return spring, and further comprising energizing or de-energizing the electrically conductive coil so as to hasten or retard moving of the piston mechanism toward the start of stroke position.

19. The method of claim 18 wherein the moving of the pumping element includes moving the pumping element to transition a liquefied gaseous fuel into the pumping chamber.

20. The method of claim 19 wherein the energizing of the electrically conductive coil further includes energizing or de-energizing the electrically conductive coil to retard moving of the piston mechanism such that flashing of the liquefied gaseous fuel is inhibited.
